(19) United States
(12) Patent Application Publication
(10) Pub. No.: US 2019/0045747 A1
(43) Pub. Date: Feb. 14, 2019

(54) METHOD OF EXERCISING ON CANINE FITNESS DEVICES FOR PUPPIES AND RELATED KIT

(71) Applicants: Deborah M. TORRACA, Colchester, CT (US); Martha M. McCormick, Colchester, CT (US)

(72) Inventors: Deborah M. TORRACA, Colchester, CT (US); Martha M. McCormick, Colchester, CT (US)

(21) Appl. No.: 15/673,181

(22) Filed: Aug. 9, 2017

(51) Int. Cl. A01K 15/02

(52) U.S. Cl. CPC A01K 15/027

(57) ABSTRACT

A method of exercising on canine fitness devices for developing co-ordination, strength and confidence in a puppy from two to twelve weeks old comprising: providing canine fitness devices selected from the group consisting of a wedge 1, a roller 2, a disk 3, a sensory physio roll 5 and at least one physio roll 7 such that the physio roll 7 is the same size or larger than the sensory physio roll 5; both the physic rolls are made of burst resistant material; positioning the puppy on or near one of said canine fitness devices by a facilitator to perform an exercise at age intervals from two to twelve weeks old, and performing said exercise by the puppy to develop co-ordination and strength, fitness and confidence.

This application claims the benefit of U.S. provisional application No. 62/373,250 filed Aug. 10, 2016 which is incorporated herein in its entirety by reference.

### FIELD OF THE INVENTION

The present invention relates to canine fitness and rehabilitation methods using fitness devices specifically designed for canines. More specifically, it relates to method for developing co-ordination, strength and confidence in a puppy for two to twelve weeks old using canine fitness devices including a burst resistant physio roll, a sensory physio roll, a disk in a solid base, a wedge and a roller.

### BACKGROUND OF THE INVENTION

Human fitness and rehabilitation is well known and has been treated for years by physical therapists. Core strengthening is a common goal of rehab patients as well as professional and semi professional athletes. Generally devices such as fitness balls and other similar devices are used to assist these individuals in core work. Representative prior art illustrating these devices include U.S. Pat. Nos. 7,306,550; 8,636,625 and 9,295,872.

Animal fitness and rehabilitation, in particular canine, is less known and more recent than the human counterpart. Physical therapy and fitness for dogs prior to 2000 did not include work with equipment or devices. There were also no methods or programs present that provided indications, contraindications and precautions.

After 2000 stretching for canines as well as strengthening for canine performance using a fitness ball was known. Use of fitness balls for canines are illustrated in the book “Canine Physical Therapy, Orthopedic Physical Therapy” by Deborah M. Gross (2002) at pages 125-129 which discusses the use of Theraballs and Physioballs, with pictures. Chapter 8 of the book also has pictures that include the ball and balance board.

U.S. Patent Publication No. 20160165846 discloses an apparatus and method for canine conditioning which utilizes two peanut shaped balls within a stationary frame.

The field of canine/animal physical therapy, or rehabilitation, is still in its adolescence. It is important to establish safe guidelines involving equipment, exercise and the like. Especially given that the field of canine fitness is not regulated by any federal standards and there is limited state legislation. Unfortunately in many U.S. States there are no restrictions or guidelines as to who can practice physical therapy and rehabilitation on animals, and these services may be performed without any regulations or supervision from trained veterinarian professionals. Since there are inherent muscular-skeletal differences between humans and canines, equipment and procedures used on humans are not necessary adequate or safe for use with canines. There is a need in the art for canine fitness exercise and conditioning programs specifically designed for puppies.

Puppies start to become active little creatures after only a few days of life, hich gives breeders the opportunity to enhance their balance, proprioception, confidence, strength, and exposure to different textures as they are growing. This invention program serves to facilitate the strength of the dogs core and balance muscles safely, without danger to their changing bodies. In the program puppies are encourage to move over objects with different surfaces, challenging their balance and core musculature while gaining confidence.

Type I muscle fibers in the body assist in balance, proprioception, postural control and core. These muscle fibers are especially important in the growing puppy, and proper development may decrease the incidence of canine hip dysplasia, elbow dysplasia, and other problems associated with lack of strength. Preliminary clinical trials have been very promising, indicating a decrease in canine hip and elbow dysplasia in many at risk breeds. In addition, articles and studies have demonstrated dogs are born with normal hips and the most crucial time period to assist in the growth of the canine hip is between one and three months of age. Surface, texture, and controlled weight bearing are a few of the factors that can positively influence the proper growth of the hip.

it is well known that most of the growth in the bones of puppies occurs between three and nine months of age. [See article entitled “Orthopedic Problems in the Immature Dog” by von Pfeil (2009)—http://vsoak.com/ww2/images/stories/pdf/Orthopedic%20Problems%20the%20Immature%20Doq.pdf]

Breeders have the opportunity to increase the amount of coordination before three months of age in that growing pup. The more exposure young pups have to different experiences, surfaces, and objects, the better. Ultimately we want a strong and confident pup.

The inventors have observed many litters of all different breeds at eight weeks for structural evaluations and have seen that there is a huge difference between puppies that have been exposed to many different objects versus those kept in an enclosed area.

The eight week old pups that have been exposed to many things are already so ahead of the game with regard to experiences, strength, and confidence. They are confident in their physical and mental abilities. Having followed many of these puppies, the inventors observed that a good number of them have gone on to successful and healthy lives with a very low incidence of orthopedic problems. Complete prevention of problems is not a realistic goal, but the more we can do to assist in improving the dogs' quality of life, the better. Since the goal is always to encourage the best quality of life for the longest time possible, why not start as young as possible?

It is also crucial to mention the surfaces that puppies grow up on. Pups should be brought up on non-slip surfaces, such as yoga mats, textured mats, and other textured surfaces. It is usually easier to clean surfaces such as a linoleum or tile floor, but this has been demonstrated to increase the instability of the puppies' movement. All of that slipping is not advantageous for their developing joints. The more grip a pup's feet can get on a surface, the less chance of sliding and the more protected their growing joints are.

The following article stresses that early strength and environmental factors are so important with puppies. http://www.nvh.no/en/Home/News/News-stories/A-number-of-environmental-factors-can-affect-the-incidence-of-hip-dysplasia-in-dogs/.

The purpose of the invention is to provide methods for canine fitness and rehabilitation, especially young puppies, using specific fitness devices for canine puppies combined with specific exercises. This combination of exercise for young puppies and use of specific fitness products does not currently exist in the prior art. The invention methods provided are used to work overall core strength of the animal and are specifically designed for growing puppies from 2 weeks until 12 weeks old, in 2 week increments.

Another purpose of the invention is to provide a uniform method for canine fitness and rehabilitation that is safe for use with young puppies.

Yet another purpose of the invention is to provide fitness devices and related methods to permit both owners and practitioners to easily follow for strengthening and improving puppies balance, proprioception and confidence.

Still another purpose of the invention is to provide fitness kits with respective fitness devices and methods for developing puppies at age intervals from two to twelve weeks.

Another purpose of the invention is to provide a series of specific exercises and progressions which are safe for use with puppies 2 to 12 weeks old to assist in fitness and rehabilitation.

Another specific objective of the invention is to introduce young puppies—between the ages of two and twelve weeks—to a variety of surfaces and challenges to their balance.

Yet another specific objective of the invention is to start developing the stability puppies need for their active lives ahead.

Yet still another objective of the invention is to start developing the Type I musculature puppies need for core strength, healthy posture and healthy growth. The development of the Type I muscle fibers is advantageous to the posture and health of a young pup.

Another objective of the invention is to increase the puppy's exposure to a variety of objects and obstacles for their physical and mental stability.

Another objective of the invention is to provide a fun method of providing exercise safely to the growing puppies.

Yet another objective of the invention is to provide fitness devices that are made of burst resistant material to prevent injury and that are safe for canine use.

In addition, another objective of the invention is to alert the breeder if a pup is developmentally delayed or challenged for early intervention. Early intervention aids in the quality of life for the pup.

### SUMMARY OF THE INVENTION

In the present invention, these purposes, as well as others which will be apparent, are achieved generally by a canine exercise program for very young puppies two to twelve weeks old, that utilizes fitness devices including a burst resistant physioroll, a sensory physioroll, a disk in a solid base, a wedge and a roller. The fitness devices include nubby surfaces for better gripping by the young pups.

Specifically, a method of exercising on canine fitness devices is provided for developing co-ordination, strength and confidence in a puppy from two to twelve weeks. The method provides canine fitness devices selected from the group consisting of a wedge 1, a roller 2, a disk 3, a sensory physio roll 5 and at least one physio roll 7 that is the same size or larger than the sensory physio roll. Both physio rolls are made of burst resistant material and is safe for canine use.

The puppy is positioned on or near one of said canine fitness devices by a facilitator to perform an exercise at age intervals from two to twelve weeks old. The exercises are performed by the puppy to develop co-ordination and strength, fitness and confidence.

The fitness devices such as the wedge 1, roller 2, disk 3 and sensory physio roll 5 preferably further include a nubby surface 6 for better gripping by the puppy.

All physio rolls used in the invention method are made of burst resistant material. This material is safe. If the canine's nails puncture the surface the device will not immediately deflate and instead will slowly and safely release air preventing injury. The physio rolls range in size from 30 cm to 85 cm depending on the age and size of the puppy. The sensory physio roll 5 is preferably 5o cm and physio roll 7 is preferably 70 cm. Typically the physio roll 7 is the same size or larger than the sensory physio roll. Also included as part of the invention method are additional sensory and/or physio rolls which can vary in size.

At the age interval of the puppy from two to three weeks of age, the preferred fitness device is the wedge 1 or roller 2. The puppy is positioned on either the wedge 1 or roller 2 in the whelping box with the exercise performed on either the wedge 1 or roller 2.

At two weeks old the puppy is positioned on a textured surface to help develop tactile feeling.

Also at this age interval the wedge 1 with a nubby surface 6 up is placed between a canine mother and a puppy right before feeding time and the puppy is positioned at the bottom of the wedge 1. The puppy is encouraged to climb up the wedge 1 towards the mother, assisted by the facilitator. This action by the puppy engages the muscles in all four of their legs and their core muscles to push themselves up and forward.

Also at this age interval the roller 2 is use. The puppy is positioned over the roller 2 so that the puppy is resting on their elbows and chest with their hind legs on the ground. The facilitator performs the exercise by gently rocking the roller 2 back and forth to assist the puppy to stand up on their hind legs.

At the age interval of when the puppy is three to four weeks of age, the fitness device introduced is the disk 3. Initially the disk has only a small amount of air in it so that it is easier for the puppy to balance on it but as the puppy gets more experience the disk can be filled with more air. The puppy is positioned on the disk 3 in the whelping box and the facilitator performs the exercise of holding the puppy in static positions on the disk 3 for a few seconds to promote muscle contraction and strengthen core and balance.

Also at this age interval the disk 3 or wedge 2 is used. The puppy is positioned on the disk 3 or wedge 2 and the exercise performed includes the facilitator rocking the disk 3 or wedge 2 back and forth or side to side to promote muscle contraction and strengthen core and balance.

At the age interval when the puppy is four weeks of age, the fitness devices used are the disk 3 and wedge 1 together. The puppy is positioned on either side of the wedge 1 or disk 3. The exercise performed includes the puppy climbing back and forth from the wedge 1 to the top of the disk 3.

At the age interval when the puppy is five weeks of age, the fitness devices used are the disk 3, wedge 1 and roller 2 together. The exercises performed include the puppy walking over the wedge 1, roller 2 and disk 3 to get to their toys or food bowls.

Also at this age interval the fitness device used is the disk 3 with base 4. The puppy is positioned with their forelimbs up on the disk 3 and the exercise performed includes the facilitator holding the puppy in place on the disk 3 for a few seconds to enhance their strength and control as well as to enhance hind limb awareness.

Another exercise with the disk 3 is positioning the puppy with their hind legs up on the disk 3 and performing the exercise where the facilitator holds the puppy in place on the disk 3 for a few seconds while the front legs are on the ground to enhance their strength and control.

A the age interval when the puppy is six weeks of age the puppy is capable of exercising on a surface that is both uneven, at different heights, and unstable, that is soft and moving, so as to work both the front and hind limbs as well as the body core muscles.

At this age fitness devices used include the disk 3 and sensory physio roll 5. The puppy is positioned standing on the disk 3 and performs the exercise including the facilitator placing the puppy's front legs on the sensory physio roll 5 and stretching the puppy up and down while steadying their hind limbs.

At the age interval when the puppy is seven weeks of age the fitness devices used are the disk 3 and sensory physio roll 5. The puppy is positioned on the sensory physio roll 5 and the exercise performed includes the puppy climbing on top of the sensory physio roll 5 and initially holding a sitting position and advancing to a standing position on top of the sensory physio roll 5.

Also at this age interval other fitness devices used include the wedge 1, disk 3 and sensory physio roll 5 together. The puppy is positioned on the wedge 1 and the exercise performed includes the puppy stepping from the wedge 1 to the disk 3 to the sensory physio roll 5.

At the age interval of the puppy at eight weeks of age the fitness device used is a sensory physio roll 5 having a nubby surface 6. The puppy is positioned on the sensory physio roll 5 and the exercise performed includes the puppy climbing on top of the sensory physio roll 5 and the facilitator shifting weight to strengthen posture and increase body awareness of the puppy.

At the age interval of the puppy from nine to twelve weeks of age the fitness devices used are the wedge 1, disk 3, sensory physio roll 5 and physio roll 70 cm 7 together. The puppy is positioned on the wedge 1 and the exercise performed includes the puppy climbing up and down from the disk 3, sensory physio roll 5 to said physio roll 70 cm 7 assisted by the facilitator.

Also part of the invention are kits for developing canine co-ordination, strength and confidence building in a puppy from two to twelve weeks old comprising canine fitness devices selected from the group consisting of a wedge 1, a roller 2, a disk 3, a sensory physio roll 5 and a burst resistant physio roll 7 and respective exercises thereon.

A kit as described above is provided for the entire 12 week period including all five fitness devices. Alternatively the following kits are provided at the respective age intervals.

A kit for the age interval of a two to three weeks old puppy to perform exercises on the wedge 1 and roller 2.

A kit for the age interval of a three to four weeks old puppy to perform exercises on the wedge 1, roller 2 and disk 3.

A kit for the age interval of a six to seven weeks old puppy to perform exercises on the wedge 1, roller 2, disk 3 and sensory physio roll 5.

A kit for the age interval of nine to twelve weeks old the puppy performs exercises on the wedge 1, roller 2, disk 3, sensory physio roll 5 and physio roll 70 cm 7.

Other objects, features and advantages of the present invention will be apparent when the detailed description of the preferred embodiments of the invention are considered with reference to the drawings, which should be construed in an illustrative and not limiting sense.

### BRIEF DESCRIPTION OF THE DRAWINGS

FIG. 1 illustrates the wedge 1 with the nubby surface side up 6 as used in the invention method. Not illustrated is the other side of the wedge which is a smooth surface.

FIG. 2 illustrates the roller device 2 used in the invention method. The device includes nubs 6.

FIG. 3 illustrates the disk 3 on the base 4; and positioned off the base. As shown the surface has nubs for better gripping by the puppy.

FIG. 4 illustrates a sensory physio roll 5 used in the invention method when the puppy is around 6 weeks old. As illustrated the physio roll is 50 cm and has a nubby surface 6 which is preferably to assist the puppy in gripping the surface.

FIG. 5 illustrates the disk 3 on the base 4, the sensory physio roll 5 and the larger physio roll 7. This setup of fitness devices is typically used for puppies between 8 to 12 weeks of age. Preferably a 50 cm sensory physio roll with nubby surface is use and a 70 cm and 85 cm physio rolls respectively, if the puppy is very large.

FIG. 6 illustrates the 2 week old puppies being introduced to the wedge 1 and roller 2 fitness devices. The puppies climb up the wedge 1 to get to their mother to nurse. The roller 2 is present for them to experience the material and texture.

FIG. 7 illustrates a 2 week old puppy being encouraged to stand up and crawl up the wedge 1.

FIG. 8 illustrates a 2 week old puppy laying across the roller 2 while it is being rolled slowly back and forth by a facilitator.

FIG. 9 illustrates a 3 week old puppy being supported while learning to hold itself up on a stationery roller 2. The facilitator is assisting by holding the puppy's hind legs in place. The wedge 1 is present to hold the roller 2 in place and to keep it from moving.

FIG. 10 illustrates a disk 3 left in the whelping box with a 4 week old puppy. The puppy climbs on the disk to develop core strength and confidence while playing and sleeping.

FIG. 11 illustrates a 5 week old puppy being supported by a facilitator on the balance disk 3 while his core muscles are working to keep him upright and balanced. The disk 3 is on a base 4.

FIG. 12 illustrates a 6 week old puppy progressing to the sensory physio roll 5 where he will eventually climb up onto in the next two weeks and learn to balance. The puppy's hind legs are on the balance disk 3 supported by the base 4 and his hind legs are on the sensory physio roll 5.

FIG. 13 illustrates a 6 week old puppy being encouraged to put his front feet on the sensory physio roll 5 while progressing up from the wedge 1 and disk 3 supported on the base 4.

FIG. 14A illustrates the physio roll 7 which is the same size or larger than the sensory roll and can be up to 85 cm depending on the size of the dog, preferably a 70 cm physio roll is used. FIG. 14B is a cross section of the material of the physio roll 7 which is made of a burst resistant quality material 8. The sensory physio roll is also made of this material.

FIG. 15 illustrates the fitness devices used at the puppy age interval from eight to twelve weeks, the disk 3, the sensory roll 5 and the physio roll 7.

### DETAILED DESCRIPTION OF THE INVENTION

As used herein the specification and as illustrated in the drawings the following structures are defined with the respective numerals:
1—Wedge (Fitness Device);
2—Roller (Fitness Device);
3—Disk (Fitness Device);
4—Disk Base (part of Fitness Device);
5—Sensory Physio Roll (Fitness Device);
6—Nubby Surface
7—Physio Roll (Fitness Device)
8—Burst resistant material

The invention provides a method of exercising on canine fitness devices for developing co-ordination, strength and confidence in a puppy from two to twelve weeks.

### Fitness Devices—Equipment

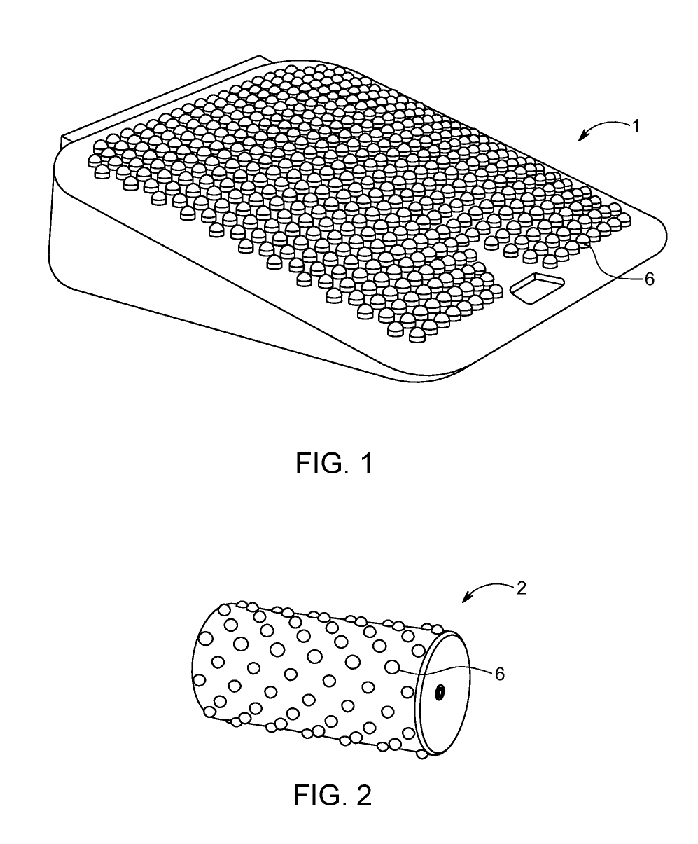

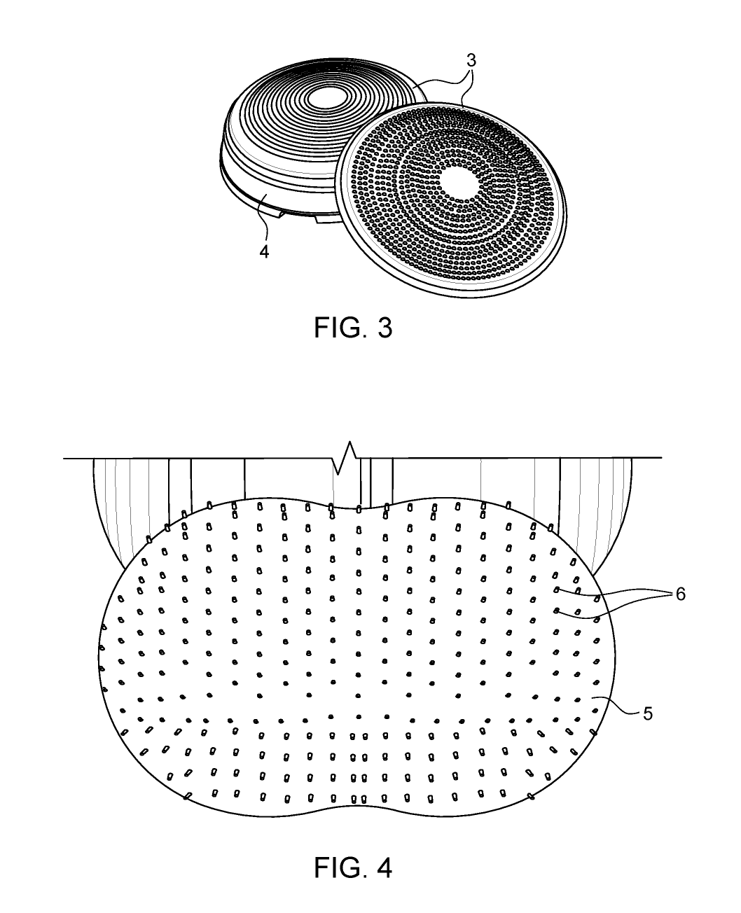

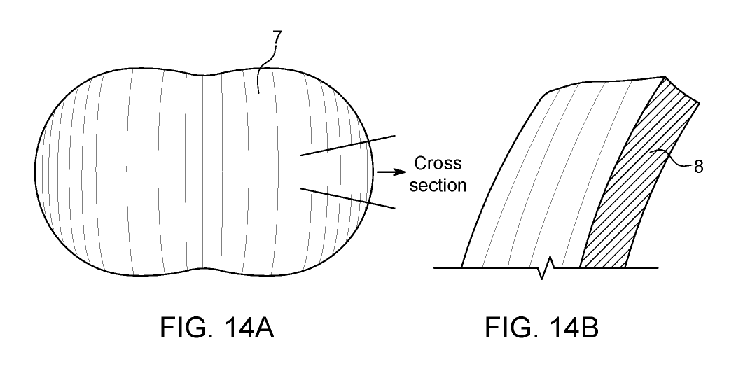

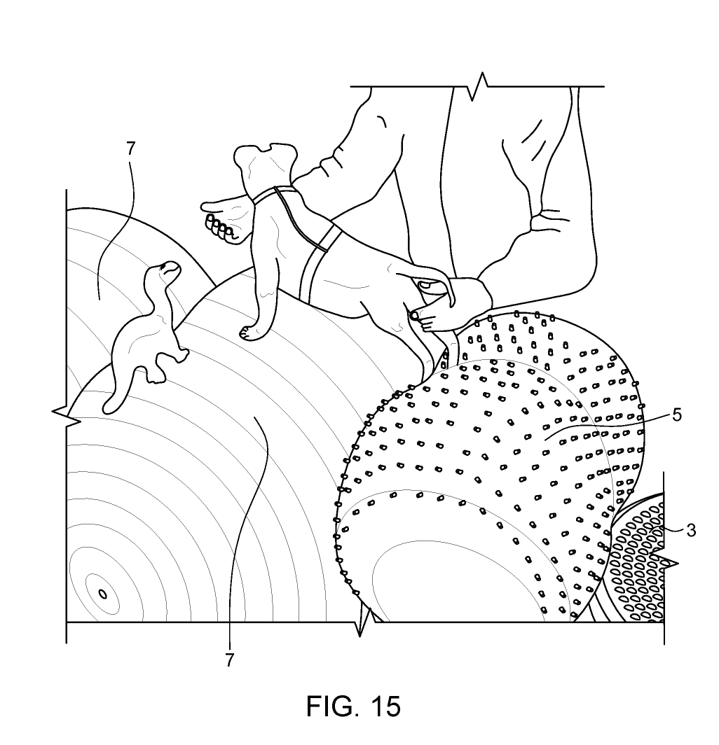

The fitness devices used in the invention are a wedge 1 (FIG. 1), a roller 2 (FIG. 2), a disk 3 with a base 4 (FIG. 3), a sensory physio roll 5 (FIG. 4), preferably with a nubby surface 5, and at least one physio roll 7 (FIG. 14A) that is the same size or larger than the sensory physio roll 5. The physio roll preferably has a smooth surface but may also in alternate embodiments have a nubby surface 6. The size of the physio rolls range from 30 cm to 85 cm depending on the age and size of the puppy. Preferably a 50 cm sensory physio roll and a 70 cm physio roll are used in the invention method. All physio rolls used in the invention method are made from burst resistant material 8 as shown in FIG. 14B.

Summarized in Table I below, the fitness devices used in the invention methods at the various puppy age intervals are shown.

TABLE I

| Device | Week 2 | Week 4 | Week 6 | Week 8-12 |
|---|---|---|---|---|
| Wedge | X | X | X | X |
| Roller | X | X | X | X |
| Disk w/base | | X | X | X |
| Sensory | | | X | X |
| Physio Roll | | | | |
| BRQ Physio | | | | X |
| Roll | | | | |

NOTE
an X means the device is used in this interval.

The invention method will now be discussed in detail at the various age intervals in the puppy's development

### Puppy Age Interval—Two to Three Weeks of Age:

These exercises are done with the wedge 1 and the roller 2 and in the whelping box, using some sort of textured surface under the pups when they are standing.

The ideal surface for a puppy is non slip or non skid so that they don't slip out or place their limbs in unnatural positions. As the puppy's stability, proprioception and balance grows and matures, they require a stable surface to improve their strength, body awareness and core ability. Slipping on surfaces may be linked to orthopedic issues. A yoga mat can be used.

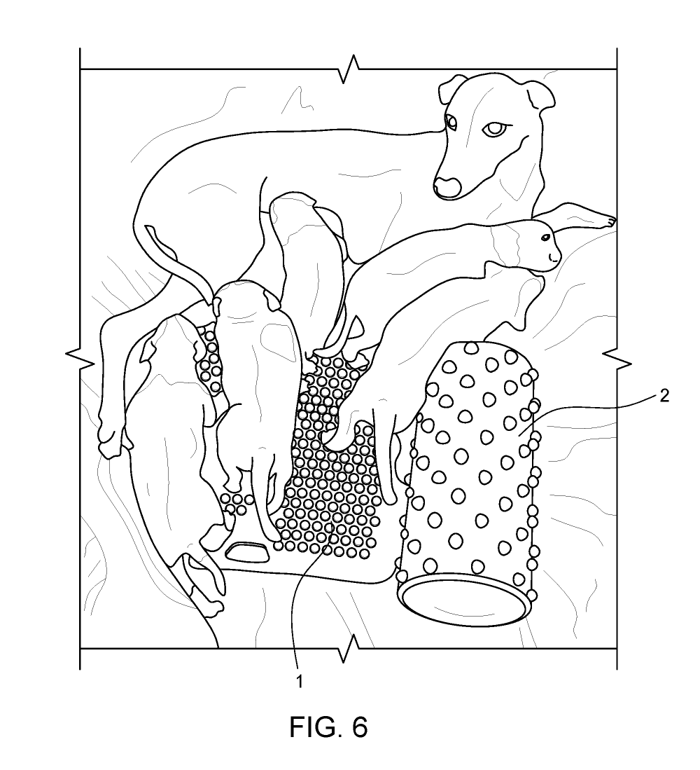

The wedge 1 device as illustrated in FIG. 6 is placed between the pups and the mother right before feeding time, nubby side up to help with traction. For smaller pups either the smooth surface is placed up or a yoga mat is placed over the wedge. The pups are encouraged to move towards their mother while climbing up the wedge. They are guided gently by the facilitator and are not allowed to fall off. The puppies in the litter are rotated through two or three times during the feeding, making sure they are not stressed or tired. The roller 2 is present for the puppy to experience the material and texture.

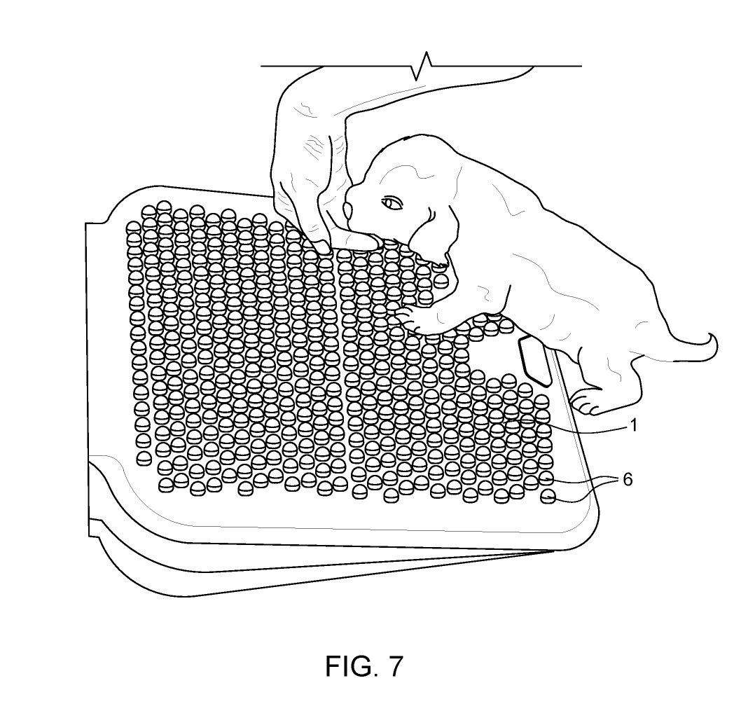

Since puppies, like humans, advance at different speeds, some of the pups are able to complete these tasks easier than others. The facilitator assists the pups that cannot make it by themselves to their mother and rewards them with a chance to nurse. If this activity is stressful in any way for a particular puppy, it is discontinued and is tried again in a day or two. As shown in FIG. 7 the puppy is moving over the wedge 1, they are starting to use the muscles in all of their legs as well as their core muscles to push themselves up and forward.

Another low impact hind leg strengthening exercise done with pups this age is where the facilitator places the palm of their hand behind the hind paws of the pups as they nurse. This usually initiates a contraction and they end up pushing back against the palm of the facilitator's hand.

The roller 2 device is used to help the pups feel different textures and to help them stand up on their hind legs. Lying the pups over the roller is a great way for them to start using their core muscles and feeling their environment. Some puppies love this from the beginning while others need a little more time to become used to the activity.

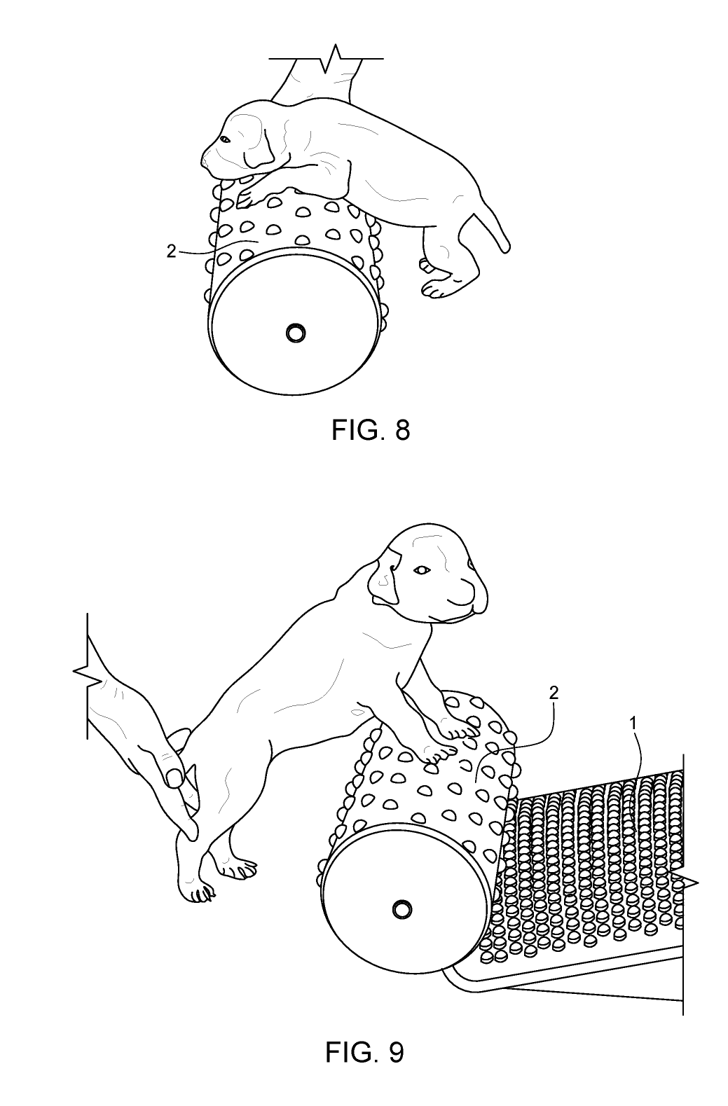

As shown in FIG. 8, the puppy is lying over the roller 2, resting on their elbows and chests with their hind legs on the ground, the facilitator can gentle roll it back and forth. Again, if the puppies are indicating they are tired or stressed, the exercise is stopped or moved to something simpler like just having them sit and rest their head or front legs on the roller without moving it.

After a few sessions, some pups may be willing and able to stand on their front legs during this exercise and they should be encouraged to do this. As larger breed pups grow throughout the week, it might be necessary to put something under the roller to raise the height so that their top lines remain straight and they do not continually try to climb onto the roller. These exercises are done 2 to 3 times a day for a week and are tailored to the individual pup's capabilities and tolerances.

### Puppy Age Interval—Three to Four Weeks of Age:

These exercises are done with the wedge 1, roller 2 and disk 3 and in the whelping box, using some sort of textured surface under the pups when they are standing.

At 3 to 4 weeks the puppies eyes are open and they are exploring the world. The disk (without the base) and/or wedge is kept in the whelping box or puppy area so the puppies can freely walk over and stand on it. The disk 3 initially has only a small amount of air in it, which makes it easier for the puppies to balance on. The surrounding edges are padded so that if the pups fall, they roll rather than go off of an elevated surface.

The wedge 1 can continued to be used as an obstacle to get to mom for feeding perhaps with a foam pad adjacent to it, so the distance to mom is increased. The puppies should be doing their roller 2 exercises 2-3 times a day, as well. As shown in FIG. 9 a three week old puppy able to hold themselves up on their front legs while on the roller 2 and puppies who can't are assisted and encouraged to do so.

The roller is good to use as they become more aware of their environment because of the texture and the way it feels on their chest, abdomen and paws—a simple tactile stimulation.

In addition, the facilitator starts to keep the puppies staying still on the various devices. Holding static positions for a few seconds is beneficial and begins to work on more core and balance, as the time of the muscle contraction is increased. While they are sitting on the disk or the wedge, the facilitator slowly rock the device, or does some gentle weight shifting back and forth by lightly pushing on alternate shoulders, side-to-side. The facilitator may assist them with this by supporting or steadying them with a hand. When they tire, they will lie down. The facilitator can still rock the disk or wedge back and forth. The puppies are allowed to leave, if they are tired or stressed. This exercise can be done along with the other two, 2-3 times a day for the next week. Additional soft surfaces may be utilized for them to explore and walk over, such as folded towels or small pillows.

When they begin to attempt some solid food, you may entice them to walk on the disc or wedge to take the food towards the end of the third week.

### PUPPY AGE INTERVAL—Four Weeks of Age:

These exercises are done with the wedge 1, roller 2 and disk 3 and in the whelping box, using some sort of textured surface under the pups when they are standing.

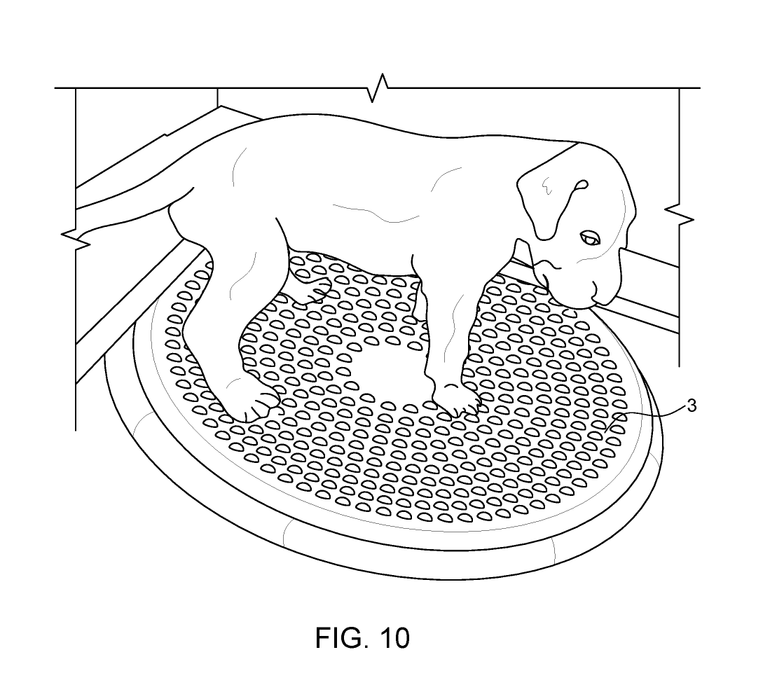

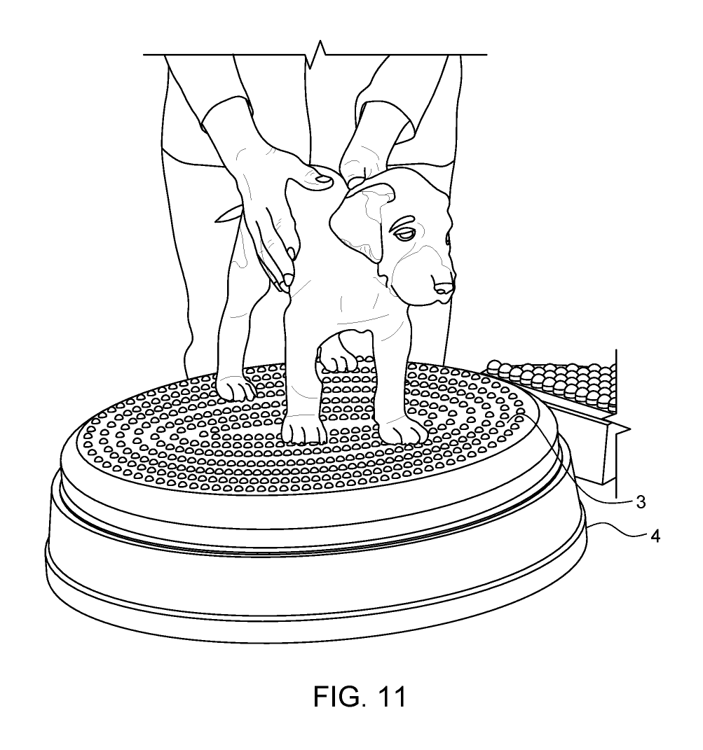

The puppies are getting stronger and most likely are spending more and more time playing with things in their environment. As shown in FIG. 10, at this stage, a higher object such as the disk 3 on the base 4 is placed in the puppy area. The facilitator encourages them to walk over it depending upon the breed of dogs. Walking back and forth over it helps with coordination and strengthening muscles. The wedge 1 is also used for smaller pups to explore on. Both sides may be utilized—the nubby surface side and the smooth surface side. The wedge 1 can also be used as a ramp to climb up to the top of the disk 3.

The equipment can be moved around throughout the day so the puppies play in different areas and arrangements each time they get up to play. At this age they do not usually chew on the equipment, and if they do, their teeth aren't strong enough to puncture it or break off pieces, but this can change as they get older.

The facilitator can encourage the puppies to stand on the disk device in a comfortable position and hold that position until signs of fatigue are seen—up to 10 seconds. The facilitator assists the ones that need it, and uses food to keep them standing still. Once they are able to stand and keep their balance on their own, some gentle weight shifts are added using hands on shoulders lightly pushing side-to-side and hands on hips gently pushing side-to-side. This engages the pup to use its core muscles to hold itself still, and eventually it will push against the facilitator for even more muscle strengthening.

At this age, they should easily be active with the equipment for up to ten minutes, four to five times a day. It's easiest to work with their schedule, so while they are up playing, take time to work with each puppy

Leaving a cushioned dog bed, large stuffed toys or pillows in with them now is a great idea. It's a soft surface for them to navigate over and exercise their new-found muscles and coordination.

### Puppy Age Interval—Five Weeks of Age:

These exercises are done with the wedge 1, roller 2 and disk 3 and are done in an area with good footing as previously described.

At this point, in the program the equipment and exercises are helping to tire the pups out. The puppies are continuing to use all of the equipment so far, leaving it in the puppy area and making sure to keep moving it around. The devices are set up in multiple ways to challenge the puppies. The facilitator encourages them to walk over a few devices to get to their toys, or to their food bowl. As they are stepping over the devices they will be working the large muscles of their legs as well as their core.

The disk 3 may now be used to encourage the dogs to place their forelimbs up and held in place. This will help with hind limb awareness. These are natural movements the puppies are performing independently, and the program enhances their strength and control. This may be further encouraged with a treat or a toy. The facilitator has them maintain the position for a couple of seconds and then return the front legs to the ground. This is also done in reverse to work on strengthening and stabilizing the front legs: back legs on the disk, front legs on the ground—maintain a straight top line. With smaller pups, the wedge 1 can be used. When they are able to hold this position easily on their own, it's time to start some weight shifting. The puppies get very excited with these activities and may want to jump up or down. The facilitator encourages balance and control. Slow and steady is better for the puppy's development.

As shown in FIG. 11, he puppy can be encouraged to stand and hold a stacked position on the disk 3. The puppy is positioned with four legs stationary, front legs straight down from the shoulders, hind legs slightly stretched behind as seen in the conformation ring on the disk 3 placing their paws in the appropriate position. This is best done with food and may be held for a few seconds. Some of their muscles may be observed working or shaking. If the puppy is nervous or starts to become very tired (yawning, sleeping, or excessive shaking) discontinue the activity. The philosophy of the program is that this should be fun and not stressful. Tracking of the time they can hold this position is documented. When they indicate they are tired by moving, give them a little break and try again. The time should increase naturally over the week as the pup continues to develop strength.

Since they are now eating solid food, this can be used to encourage them to do their own ‘weight shifting.’ While they are standing still, the facilitator will ask them to follow a treat up and down with their heads. They can also follow a treat side-to-side, again while keeping their feet in one place. The facilitator can help them to stand still with a hand under their abdomen just in front of their hind legs. This can be done with four feet on the disk or two feet up/two feet down.

### Puppy Age Interval—Six Weeks of Age:

These exercises are done with the wedge 1, roller 2, disk 3 and sensory physio roll 5 and are done in an area with good footing where the dog can get good traction where it will not slip.

In the earlier stages the pups worked with both feet on a level unstable surface (the disk) and with front legs on an unstable surface and hind legs on a stable surface and visa-versa (disk and ground). The next step for the puppy is to work safely on a surface that is both uneven (at different heights) and unstable (soft and moving). This position works both the front and hind limbs, as well as the body core muscles.

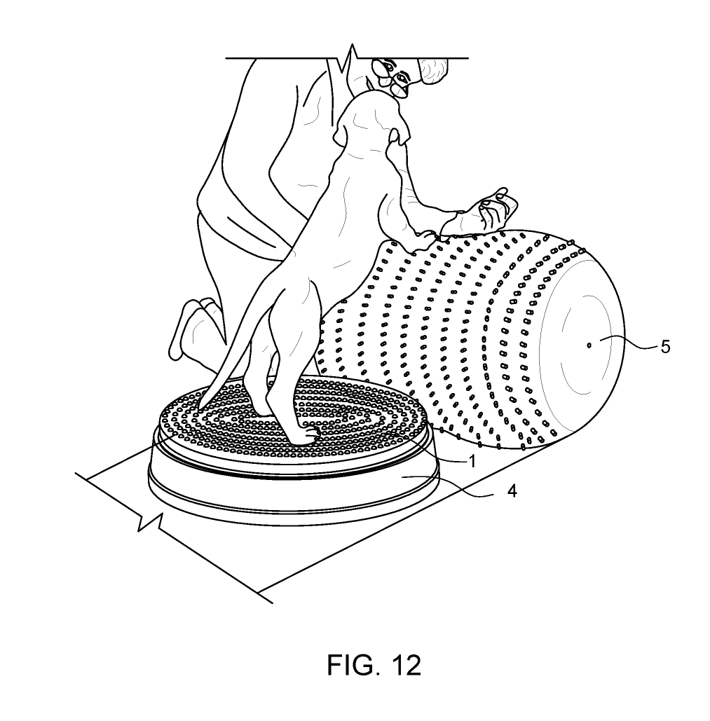

As shown in FIG. 12 hind leg strengthening is the focus of the exercise when the front legs are up. Front leg strengthening is the focus when the front legs are down.

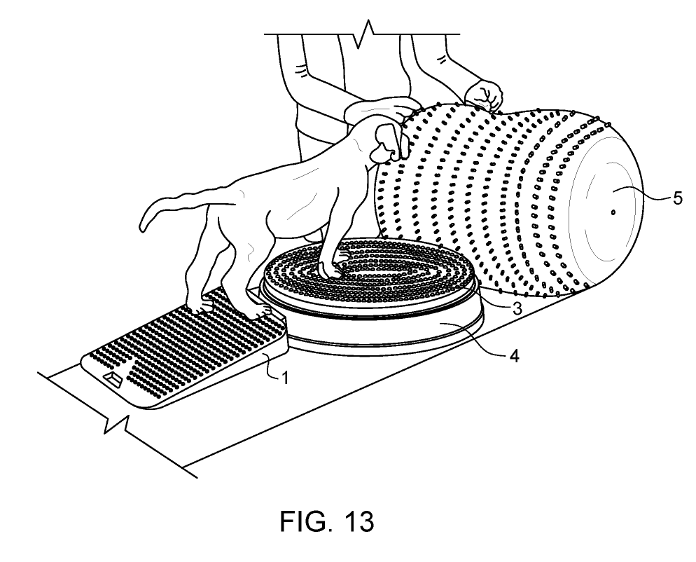

This can be done with the wedge 1 and the disk 3 and base 4, or for larger pups, with the disk 3 and the sensory physio roll 5 as shown in FIG. 13. The puppy should be encouraged to stand on the disk 3 and place their front legs on the nubby physio roll 5. The physio roll is secured in place so that it will not roll. When the puppy is comfortable holding this position, the facilitator has them move their head up and down and side to side with a treat. It is preferably to use the disk 3 with the base 4 along with the wedge 1 to work on their front legs: hind legs on the disk 3, front legs on the highest part of the wedge 1. The facilitator encourages them to do the same gentle weight shifting as when they were in the upward position.

These methods help the puppy to get accustomed to the movement of the equipment, and prepares their muscles to climb up and down the physio rolls. At this point, the puppies are encouraged to stretch up and stretch down, by holding a treat out beyond their reach, and steadying their hind limbs with the facilitators hand in front of them. This is again preparation for the climbing motion. It is also a great start for a beautiful conformation stack as previously described.

### Puppy Age Interval—Seven Weeks of Age

These exercises are done with the wedge 1, roller 2, disk and sensory physio roll 5 and are done in an area with good footing as previously described.

As the puppies continue to grow and spend more time playing, they are continued to be exposed to more fitness devices and they are encouraged to have more independent play workouts, walking up, down and over the fitness devices.

The sensory physio roll 5 is now introduced. It is secured in place so that it does not roll. The facilitator might initially place a hand on it while the puppy is up there until the pup develops the skill and muscles needed to keep the physio roll 5 from shaking.

The puppy is placed on top of the nubby physio roll in a sitting position initially, until they are comfortable with the height. This may take a few sessions with some puppies. Once they are okay with sitting, they are placed in a standing position and encouraged to stay there with food.

The puppies at this age may not be able to stand on their own and may need assistance by the facilitator A harness is recommended for core work at this height on the sensory physio roll which can range from 30 cm to 85 cm—safety is always priority. Holding the puppy on the sensory physio roll 5 for a few seconds while it lays down, sits or stands continues to build up their core musculature, balance, control and proprioception. The textured material offers a perfect surface for their toes to grip and promotes confidence.

The facilitator may also place the wedge 1, the disc 2 with the base 4, and the sensory physio roll 5 together and encourage them to step up from one to the other. Because of their size, toy and small breeds may not be able to climb onto the sensory physio roll 5 at this age due to their size but many other larger breeds will. Using the position they practiced during week 6, both front legs on the sensory physio roll 5 and hind legs on the disc, the facilitator will lift one of their hind legs and place the paw up onto the sensory physio roll 5 while encouraging forward motion with food. It's surprising how quickly they learn to dig in and push, propelling them onto the top. The facilitator can help them to climb down in the same manner, but is sure to have hold of their harness so that they do it slowly and safely.

As always, puppies should never be forced to do anything they are afraid of or are unable to do. As puppies go through their fear stage, they may need to be brought back to simpler, familiar exercises. Often, light bouncing on the nubby physio roll will help calm them down. This is analogous to rocking a baby.

### Puppy Age Interval—Eight Weeks of Age:

These exercises are done with the wedge 1, roller 2, disk 3 and sensory physio roll 5and are done in an area with good footing as previously described.

At this age the pups should be pretty confident with the different pieces of equipment and their core strength should be developing nicely. As the pups grow, some of them may have more muscle development and more ability than others. This is not a problem since each puppy will develop at its own rate.

The puppies should be climbing onto the disk 3 on the base 4 and sensory physio roll 5 with relative ease now. The facilitator should stop and hold a position at each level, so the puppy learns not to rush. It's also the holding part that builds the most strength. So, climb, hold in the climb position, stretch, weight shift, and up onto the next level. The same method is done on the way down. The routine can be varied and fun so the puppy can't predict what's next and learn to keep their focus on the exercises.

At the top, where things are level, but very unstable, some weight shifting is started. Target training is taught here, or “Touch” and make the pup touch their nose to the faciliator's hand for a reward. The position of the hand can be changed each time, and make the puppy shift their weight. The puppy can also be taught to turn half way and completely around on top of the physio roll 5. The pup can stand and give a paw; or can lift one leg up at a time. When a pup is on top of the physio roll 5 performing these movements and learning to keep its balance, the facilitator should have one hand on them at all times, and of course they should be wearing a harness.

Ten minutes of this easy dynamic up and down routine is a good time to strive for at this age.

These exercises are much easier for a puppy than an adult dog—especially a large breed—but if a puppy has learned them when they are young and has built confidence and core strength as a result, they will do them successfully when they are older.

Most puppies are getting ready for their new homes and what a great start they have had after this exercise program. At eight weeks, their body awareness, strong posture and confidence should be evident. The pups headed to the conformation ring have a great base for free stacking and standing. Those who may be headed to performance homes have the beginnings of body awareness and muscle tone. And those who will be someone's cherished pet will leave with confidence and balance.

### Puppy Age Interval—Nine-Twelve Weeks of Age

These exercises are done with the wedge 1, roller 2, disk 3, sensory physio roll 5 and physio roll 7 and are done in an area with good footing as previously described. The physio roll 7 used in the invention method is preferably larger than the sensory physio roll 5.

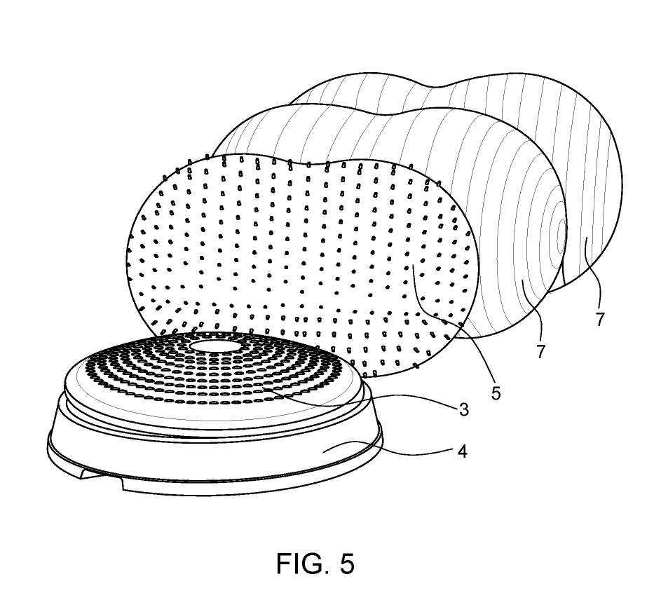

The physio rolls used in the invention range in size from 30 cm to 80 cm depending on the size and age of the puppy. Preferred sizes are 50 cm for the sensory physio roll 5 and 70 cm for the physio roll 7. The fitness devices used in the method at the age interval is illustrated in FIG. 5. This illustration shows two physio rolls 7 in addition to the sensory roll 5.

The Norwegian School of Veterinary Science study concludes that the window of opportunity where environmental factors appear to influence the incidence of Hip Dysplasia is from birth to twelve weeks. Accordingly, the puppies should continue the 8-week program at least up until twelve weeks of age. This is especially important in large or giant breed puppies. The invention program of low impact, non-concussive, non-repetitive motion done on soft, tactile surfaces through the age of three months should continue to enhance muscle and joint stability.

As shown in FIG. 14A the larger physio roll 7 is used in this age group, to accommodate the growth in size and weight of young pups. All physio rolls used in the invention method are unique burst resistant quality 8 inflatable canine fitness products which are the ultimate in safety. The outer material is slightly textured and provides grip. The burst resistant quality is used over standard quality materials which are easy to tear and burst, thereby preventing a puppy from falling if there is an accident related to the physio roll or other fitness device. The slow release of air from the invention physio rolls prevents the puppy from suddenly falling and potentially becoming injured. No other fitness devices use this material.

FIG. 14B is a cross section of the physio roll 7 and shows how thick the burst resistant material is which is essentially a thick inner porous foam like material with an by outer surface non porous material. These materials are safe for use by canines.

During this time period, the puppy is building confidence and strength as they move up and down from disk 3 with base 4, nubby physio roll 5 to the larger physio roll 7 Weight shifting motions, either manual or through the dog's own motion should be done while pups are in a static position on the equipment. Tricks and training can begin, as well: sit-to-stand on the disk or physio roll, more advanced target training, and other taught skills that will be used in the dog's future as a pet or performance dog.

The 8-11 week of age time frame is often referred to as the first Fear Impact Period, where puppies may be more easily traumatized by scary events. The confidence they have built up through the first weeks of this program, along with new positive experiences on the equipment will help them through this. The Fear Impact period is another advantage for using safe burst resistant quality fitness devices. If an accident happens at this age the puppy can be traumatized for its entire life.

These methods of the invention are continued when the puppy moves on to their new home, particularly, until they are three months old (12 weeks). Rapidly growing pups may need to advance onto larger size physio rolls up to 85 cm during this time.

With the invention program, breeders can feel confident that they have given their pups a great foundation for mental and orthopedic health.

Possible variations include additional exercises and/or similar fitness devices to assist the 2-12 week old puppy to gain greater co-ordination and strength. For instance balance pods can be used which are specially designed to have a 1 inch hole on the bottom. This is so that a pole can be placed in them to stabilize other fitness devices like the physio rolls.

The fitness devices used in the invention are preferably purple which is a color most easily seen by canines.

The foregoing description of various and preferred embodiments of the present invention has been provided for purposes of illustration only, and it is understood that numerous modifications, variations and alterations may be made without departing from the scope and spirit of the invention as set forth in the following claims.

What is claimed is:

1. A method of exercising on canine fitness devices for developing co-ordination, strength and confidence in a puppy from two to twelve weeks old comprising:
providing canine fitness devices selected from the group consisting of a wedge 1, a roller 2, a disk 3, a sensory physio roll 5 and at least one physio roll 7, such that said physio roll 7 is the same size or larger than said sensory physio roll 5;
positioning the puppy on or near one of said canine fitness devices by a facilitator to perform an exercise at age intervals from two to twelve weeks old, and performing said exercise by the puppy to develop co-ordination and strength, fitness and confidence.

2. The method according to claim 1, wherein said fitness devices are the wedge 1, roller 2, disk 3 and sensory physio roll 5 and further include a nubby surface 6 for better gripping by the puppy.

3. The method according to claim 1, wherein said sensory physio roll 5 and said physio roll 7 are made from burst resistant material and range in size from 30 cm to 85 cm.

4. The method according to claim 1, wherein said age interval of the puppy is two to three weeks of age; wherein said fitness device is the wedge 1 or roller 2;
positioning said puppy on either said wedge 1 or roller 2 in the whelping box; and
performing said exercise on either said wedge 1 or roller 2.

5. The method according to claim 4, wherein the puppy is positioned on a textured surface.

6. The method according to claim 4, wherein said fitness device is the wedge 1 with a nubby surface 6 up is placed between a canine mother and a puppy right before feeding time; positioning the puppy at the bottom of said wedge 1, and performing said exercise comprising the puppy climbing up said wedge 1 towards the mother, assisted by the facilitator, wherein the puppy engages the muscles in all four of their legs and their core muscles to push themselves up and forward.

7. The method according to claim 4, wherein said fitness device is the roller 2;
positioning the puppy over said roller 2 so that the puppy is resting on their elbows and chest with their hind legs on the ground and performing said exercise comprising the facilitator gently rocking said roller 2 back and forth to assist the puppy to stand up on their hind legs.

8. The method according to claim 1, wherein said age interval of the puppy is three to four weeks of age, said fitness device is the disk 3 which initially has only a small amount of air in it so that it is easier for the puppy to balance on it; positioning the puppy on said disk 3 in the whelping box and performing said exercise comprising the facilitator holding the puppy in static positions on said disk 3 for a few seconds to promote muscle contraction and strengthen core and balance.

9. The method according to claim 8, wherein said fitness device is the disk 3 or wedge 2; positioning the puppy on said disk 3 or wedge 2 and performing said exercise comprising the facilitator rocking said disk 3 or wedge 2 back and forth or side to side to promote muscle contraction and strengthen core and balance.

10. The method according to claim 1, wherein said age interval of the puppy is four weeks of age; wherein said fitness devices are the disk 3 and wedge 1 together;
positioning the puppy on either said wedge 1 or said disk 3; and performing said exercise comprising the puppy climbing back and forth from said wedge 1 to the top of said disk 3.

11. The method according to claim 1, wherein said age interval of the puppy is five weeks of age; wherein said fitness devices are the disk 3, wedge 1 and roller 2 together; and performing said exercise comprising the puppy walking over said wedge 1, roller 2 and disk 3 to get to their toys or food bowls.

12. The method according to claim 11, wherein said fitness device is the disk 3 with base 4; positioning the puppy with their forelimbs up on said disk 3 and performing said exercise comprising the facilitator holding the puppy in place on said disk 3 for a few seconds to enhance their strength and control as well as to enhance hind limb awareness.

13. The method according to claim 11, wherein said fitness device is the disk 3;
positioning the puppy with their hind legs up on said disk 3 and performing said exercise comprising the facilitator holding the puppy in place on said disk 3 for a few seconds while the front legs are on the ground to enhance their strength and control.

14. The method according to claim 1, wherein said age interval of the puppy is six weeks of age and performing said exercise comprising holding the puppy in place on a surface that is both uneven, at different heights, and unstable, that is soft and moving, so as to work both the front and hind limbs as well as the body core muscles.

15. The method according to claim 14, wherein said fitness devices are said disk 3 and sensory physio roll 5; positioning the puppy standing on said disk 3 and performing said exercise comprising the facilitator placing the puppy's front legs on said sensory physio roll 5 and stretching the puppy up and down while steadying their hind limbs.

16. The method according to claim 1, wherein said age interval of the puppy is seven weeks of age; said fitness devices are said disk 3 and sensory physio roll 5; positioning the puppy on said sensory physio roll 5 and performing said exercise comprising the puppy climbing on top of said sensory physio roll 5 and initially holding a sitting position and advancing to a standing position on top of said sensory physio roll 5.

17. The method according to claim 16, wherein said fitness devices are said wedge 1, disk 3 and sensory physio roll 5 together; positioning said the puppy on said wedge 1; and performing said exercise comprising the puppy stepping from the wedge 1 to the disk 3 to the sensory physio roll 5.

18. The method according to claim 1, wherein said age interval of the puppy is eight weeks of age; said fitness device is a sensory physio roll 5 having a nubby surface 6; positioning the puppy on said sensory physio roll 5 and performing said exercise comprising the puppy climbing on top of said sensory physio roll 5 and the facilitator shifting weight to strengthen posture and increase body awareness of the puppy.

19. The method according to claim 1, wherein said age interval of the puppy is nine to twelve weeks of age; said fitness devices are the wedge 1, disk 3, sensory physio roll 5 and physio roll 7 together; positioning the puppy on said wedge 1 and performing said exercise comprising the puppy climbing up and down from said disk 3, sensory physio roll 5 to said physio roll 7 assisted by the facilitator.

20. A kit for developing canine co-ordination, strength and confidence building in a puppy from two to twelve weeks old comprising canine fitness devices selected from the group consisting of a wedge 1, a roller 2, a disk 3, a sensory physio roll 5 and at least one physio roll 7; both said sensory phyiso roll 5 and said physio roll 7 are made of burst resistant material; wherein
at the age interval of two to three weeks old the puppy performs exercises on said wedge 1 and roller 2;
at the age interval of three to four weeks old the puppy performs exercises on said wedge 1, roller 2 and disk 3;
at the age interval of six to seven weeks old the puppy performs exercises on said wedge 1, roller 2, disk 3 and sensory physio roll 5; and
at the age interval of nine to twelve weeks old the puppy performs exercises on said wedge 1, roller 2, disk 3, sensory physio roll 5 and at least one physio roll 7.
